(19) United States
(12) Patent Application Publication
(10) Pub. No.: US 2021/0089867 A1
(43) Pub. Date: Mar. 25, 2021

(54) DUAL RECURRENT NEURAL NETWORK ARCHITECTURE FOR MODELING LONG-TERM DEPENDENCIES IN SEQUENTIAL DATA

(71) Applicant: NVIDIA Corporation, Santa Clara, CA (US)

(72) Inventors: Wonmin Byeon, Santa Clara, CA (US); Jan Kautz, Lexington, MA (US)

(21) Appl. No.: 16/581,099

(22) Filed: Sep. 24, 2019

(51) Int. Cl. G06N 3/04; G06N 3/08

(52) U.S. Cl. CPC G06N 3/0454; G06N 3/08; G06N 3/0445

(57) ABSTRACT

Learning the dynamics of an environment and predicting consequences in the future is a recent technical advancement that can be applied to video prediction, speech recognition, among other applications. Generally, machine learning, such as deep learning models, neural networks, or other artificial intelligence algorithms are used to make the predictions. However, current artificial intelligence algorithms used for making predictions are typically limited to making short-term future predictions, mainly as a result of 1) the presence of complex dynamics in high-dimensional video data, 2) prediction error propagation over time, and 3) inherent uncertainty of the future. The present disclosure enables the modeling of long-term dependencies in sequential data for use in making long-term predictions by providing a dual (i.e. two-part) recurrent neural network architecture.

### TECHNICAL FIELD

The present disclosure relates to recurrent neural networks used for future state prediction.

### BACKGROUND

Learning the dynamics of an environment and predicting consequences in the future is a recent technical advancement having numerous applications. These applications include video prediction, speech recognition, etc., and they generally use machine learning such as deep learning models, neural networks, or other artificial intelligence algorithms to make predictions. In one example, a common application is to train a model (e.g. deep learning model) that accurately predicts pixel-level future frames of video conditioned on past frames of video. This particular application can be utilized for intelligent agents to guide them to interact with the world, or for other video analysis tasks such as activity recognition.

However, current artificial intelligence algorithms used for making predictions, such as those mentioned above, exhibit various limitations. For example, current techniques are typically limited to making short-term future predictions. For example, the Convolutional Long Short-Term Memory (ConvLSTM) network, which has been a popular model architecture choice for video prediction, is able to produce high-quality predictions only for one or less than ten frames. In the context of video prediction, learning to predict long-term future video frames remains challenging due to 1) the presence of complex dynamics in high-dimensional video data, 2) prediction error propagation over time, and 3) inherent uncertainty of the future.

There is a need for addressing these issues and/or other issues associated with the prior art.

### SUMMARY

A method, computer readable medium, and system are disclosed to provide a dual recurrent neural network architecture for modeling long-term dependencies in sequential data. As a first part, the dual recurrent neural network architecture includes a history recurrent neural network configured to process an input sequence to learn a cell state transition function from a set of hidden states associated with the input sequence. As a second part, the dual recurrent neural network architecture includes an update recurrent neural network configured to update a current cell state and corresponding hidden states for each input of the input sequence, based on the cell state transition function.

### BRIEF DESCRIPTION OF THE DRAWINGS

FIG. 1 illustrates a flowchart of a dual recurrent neural network architecture method, in accordance with an embodiment.

FIG. 2 illustrates a block diagram of a dual recurrent neural network architecture system, in accordance with an embodiment.

FIG. 3 illustrates an attention mechanism for one implementation of the dual recurrent neural network architecture system of FIG. 2, in accordance with an embodiment.

FIG. 4 illustrates skip connections for one implementation of the dual recurrent neural network architecture system of FIG. 2, in accordance with an embodiment.

FIG. 5 illustrates an architecture for each of the recurrent neural networks in the dual recurrent neural network architecture system of FIG. 2, in accordance with an embodiment.

FIG. 6A illustrates inference and/or training logic, in accordance with an embodiment.

FIG. 6B illustrates inference and/or training logic, in accordance with an embodiment.

FIG. 7 illustrates training and deployment of a neural network, in accordance with an embodiment.

FIG. 8 illustrates an exemplary system, in accordance with an embodiment.

### DETAILED DESCRIPTION

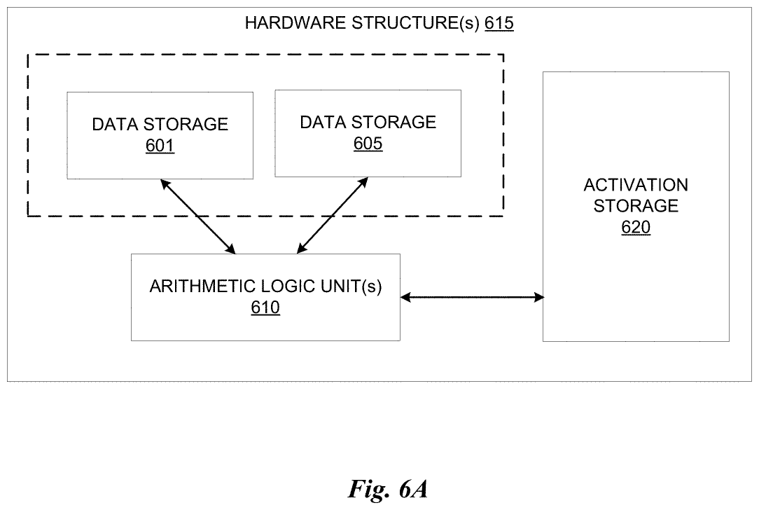

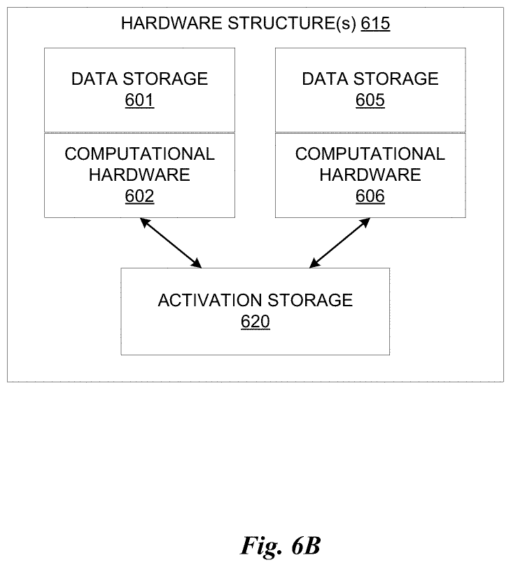

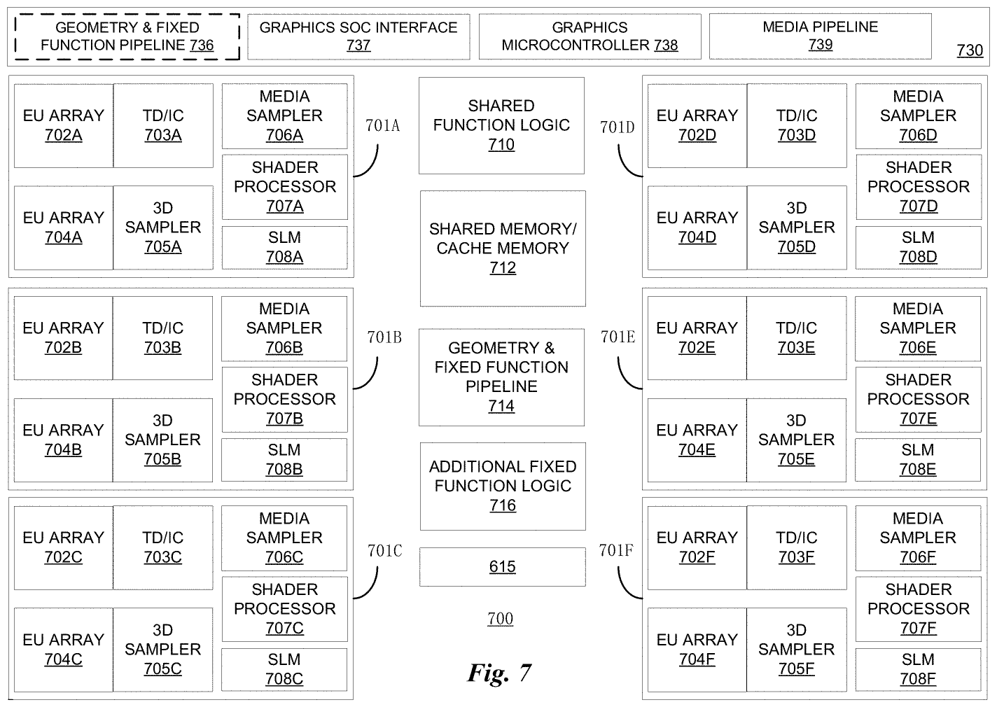

Neural networks, in general, are a series of algorithms that can be trained to make predictions (inferences). Given some input, a trained neural network can predict, or infer, output. More information regarding general neural networks is provided below with reference to FIGS. 6A-7.

Recurrent neural networks, on the other hand, improve traditional neural networks by including a node loop to allow information to persist across each step of the loop. Since each node of a recurrent neural network is looped to the next, where the output of one node is input to the next node, the recurrent neural networks are often used in applications involving sequential data. The recurrent neural network has some internal (cell) state that it is updated based on some function for each node, and then is provided as the output to the next node. The complexity of the function can vary based on the type of recurrent neural network employed. In any case, each node will receive both the output of the previous node as well as some additional input from an input sequence for processing. However, some history is invariably lost or discarded over time when using traditional recurrent neural networks.

The present disclosure provides a recurrent neural network architecture involving two recurrent neural networks that operate in combination to model long-term dependencies in sequential data.

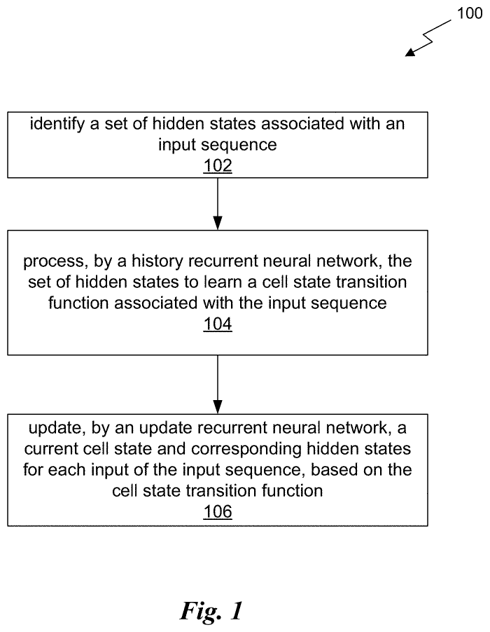

FIG. 1 illustrates a flowchart of a dual recurrent neural network architecture method 100, in accordance with an embodiment. The method 100 may be performed by a computer processor, a program, custom circuitry, or a combination thereof. For example, the method 100 may be executed by a GPU (graphics processing unit) and/or a CPU (central processing unit). Furthermore, persons of ordinary skill in the art will understand that any system that performs method 100 is within the scope and spirit of embodiments of the present disclosure.

As shown in operation 102, a set of hidden (history) states associated with an input sequence is identified. The input sequence may be any sequence of data, such as a sequence of video frames, a sequence of speech, etc. In one embodiment, each portion (e.g. frame) of the input sequence may be associated with a different timestamp, such that the input sequence may be a time-based sequence of data.

In one embodiment, the input sequence may be provided (e.g. selected) as input to the dual recurrent neural network architecture. For example, the input sequence may be provided for the purpose of predicting long-term future data from the input sequence.

As shown in operation 104, a history recurrent neural network processes the set of hidden states to learn a cell state transition function associated with the input sequence. In various embodiments, the history recurrent neural network may be a long short-term memory (LSTM) network, a convolutional long short-term memory (ConvLSTM) network, a gated recurrent unit (GRU) network, or any other recurrent neural network (RNN) having repeating nodes capable of processing the input sequence to learn the cell state transition function for the input sequence.

In the context of the present description, the cell state transition function refers to the function by which the cell and hidden states of each node is changed. The cell state transition function may remove data from the cell state, add data to the cell state, update values in the cell state, merge the cell state with one or more the hidden states, and/or change the cell and hidden states in any other way.

As noted above, the history recurrent neural network uses the set of hidden states associated with the input sequence to learn the cell state transition function. In one embodiment, the set of hidden states may include all hidden states associated with the input sequence. In another embodiment, the history recurrent neural network may include an attention mechanism, which may be applied to the set of hidden states associated with the input sequence. The attention mechanism may compute, for a time step k, a relationship between a last hidden state and each earlier hidden state to indicate a weight for each earlier hidden state. In the context of video frames, computing attention using the hidden states (instead of input frames) takes into account the spatio-temporal context of each frame in addition to the pixel-level information in the frame itself, which is more suitable for computing frame-level attention for videos. In general, the attention information propagates through recurrent connections, and output of the attention mechanism may then be used for the purpose of learning the cell state transition function.

Further, as shown in operation 106, an update recurrent neural network updates a current cell state and corresponding hidden states for each input of the input sequence, based on the cell state transition function. Similar to the history recurrent neural network, the update recurrent neural network may be a LSTM network, a ConvLSTM network, a GRU network, etc., but of course may be any RNN having repeating nodes capable of using the cell state transition function learned by the history recurrent neural network to update cell states and corresponding hidden states in the update recurrent neural network.

To this end, by separating the history and update functionality into two separate recurrent neural networks, namely the history recurrent neural network and the update recurrent neural network, a dual recurrent neural network architecture is formed that models long-term dependencies in sequential data represented by the input sequence. In turn, the dual recurrent neural network architecture can be used to predict long-term future data from the input sequence.

In one optional embodiment, a loss function may be utilized to train the history recurrent neural network and/or the update recurrent neural network. Further still, a perceptual loss may be utilized to train the history recurrent neural network and the update recurrent neural network. In another optional embodiment, a skip connection may be utilized between previous and current recurrent layers, for example to concatenate output of the previous and current recurrent layers. In yet another optional embodiment, a gated skip connection may be utilized across layers, for example as a multiplicative gate added to control a flow of information across layers.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

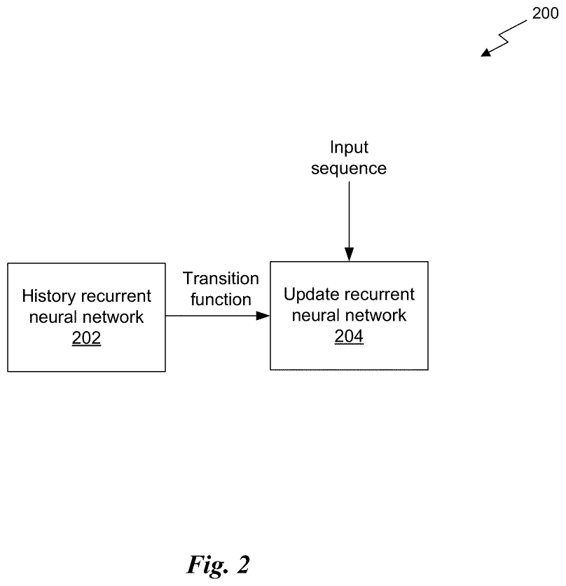

FIG. 2 illustrates a block diagram of a dual recurrent neural network architecture system 200, in accordance with an embodiment. For example, the dual recurrent neural network architecture system 200 may be implemented to carry out the method 100 of FIG. 1.

As shown, the dual recurrent neural network architecture system 200 includes a history recurrent neural network 202 and an update recurrent neural network 204. The history recurrent neural network 202 and the update recurrent neural network 204 may both be LSTM networks, ConvLSTM networks, GRU networks, etc.

The history recurrent neural network 202 receives as input a set of hidden states associated with an input sequence. The history recurrent neural network 202 processes the set of hidden states to learn a cell state transition function from a set of hidden states associated with the input sequence. The history recurrent neural network 202 outputs the cell state transition function to the update recurrent neural network 204.

The update recurrent neural network 204 receives as input the input sequence, as well as the cell state transition function as mentioned above. The update recurrent neural network 204 updates a current cell state and corresponding hidden states for each input of the input sequence, based on the cell state transition function.

In combination, the history recurrent neural network 202 and the update recurrent neural network 204, also referred to as the dual recurrent neural network architecture system 200, are able to model long-term dependencies in sequential data represented by the input sequence, and thus can be used to predict long-term future data from the input sequence. The long-term future data may be predicted with less degradation over time than with use of traditional RNNs and the like. Various applications for the update recurrent neural network 204 include video prediction (e.g. for robotics, autonomous driving, human computer interaction, etc.), language modeling, speech recognition, object/human trajectory prediction, etc.

Exemplary Implementation

The following description discloses an embodiment of the dual recurrent neural network architecture system 200 implemented using ConvLSTM networks.

To effectively learn dynamics from the history states, the dual recurrent neural network architecture system 200 can be implemented as two ConvLSTM networks, one being a History LSTM (H-LSTM) and the other being an Update LSTM (U-LSTM), also referred to as Double LH-STM. The goal of the dual recurrent neural network architecture system 200 is to explicitly separate the long-term history memory and the update memory. By disentangling these, the model can better encode high-dimensional long-range history and keep track of the their dependencies.

The H-LSTM block explicitly learns the complex transition function from the (possibly entire) set of hidden states, H_{k-m:k-1}, 1<m<k. If m=k, H-LSTM incorporates the entire history up to the time step k−1.

Where a traditional ConvLSTM network is formulated as shown in Equation 1 below, the H-LSTM may be formulated to include an attention mechanism (HistAtt) as shown in Equation 2 below.

Let X₁ⁿ={X₁, . . . , Xₙ} be an input sequence of length n. Xₖ∈ [symbol] ^{h×w×c} is the k-th frame, where k∈{\tilde{1}, . . . , ñ}, h is the height, w the width, and c the number of channels. For the input frame Xₖ, the ConvLSTM network computes the current cell and hidden states (Cₖ, Hₖ) given the cell and hidden states from the previous frame, (Cₖ₋₁, Hₖ₋₁):

Cₖ,Hₖ=ConvLSTM(Xₖ,Hₖ₋₁,Cₖ₋₁),

by computing the input, forget, output gates iₖ, fₖ, oₖ, and the transformed cell state \tilde{C}ₖ:

iₖ=σ(Wᵢ*Xₖ+Mᵢ*Hₖ₋₁+bᵢ),

fₖ=σ(W_{f}*Xₖ+M_{f}*Hₖ₋₁+b_{f}),

oₖ=σ(Wₒ*Xₖ+Mₒ*Hₖ₋₁+bₒ),

Ĉₖ=tan h(W_{ĉ}*Xₖ+M_{ĉ}*Hₖ₋₁+b_{ĉ}),

Cₖ=fₖ⊙Cₖ₋₁+iₖ⊙Ĉₖ,

Hₖ=oₖ⊙ tan h(Cₖ), Equation 1

where σ is the sigmoid function, W and M are 2D convolutional kernels for input-to-state and state-to-state transitions. (*) is the convolution operation, and (⊙) is element-wise multiplication. The size of the weight matrices depends on the size of convolutional kernel and the number of hidden units.

iₖ₋₁′=σ(Mᵢ′*Hₖ₋₁+HistAtt(Hₖ₋₁,H_{k-m:k-2})+bᵢ′),

fₖ₋₁′=σ(M_{f}′*Hₖ₋₁+HistAtt(Hₖ₋₁,H_{k-m:k-2})+b_{f}′),

oₖ₋₁′=σ(Mₒ′*Hₖ₋₁+HistAtt(Hₖ₋₁,H_{k-m:k-2})+bₒ′)

Ĉₖ₋₁′=tan h(M_{ĉ}′*Hₖ₋₁+HistAtt(Hₖ₋₁,H_{k-m:k-2})+b_{ĉ}′),

Cₖ₋₁′=fₖ₋₁′⊙Cₖ₋₂′+iₖ₋₁′⊙Ĉₖ₋₁′,

Hₖ₋₁′=oₖ₋₁′⊙ tan h(cₖ₋₁)′, Equation 2

The HistAtt unit uses a dot-product-based self-attention mechanism. This attention mechanism can be formulated as Att(Q, K, V)=softmax(W^{Q}Q·W^{Q}K)·W^{Q}V. It consists of queries (Q), keys (K) and values (V). It computes the dot products of the queries and the keys and then applies the softmax function. Finally, the values (V) are weighted by the outputs of the softmax function. The queries, keys, and values can be optionally transformed by the W^{Q}, W^{K}, and W^{V} matrices.

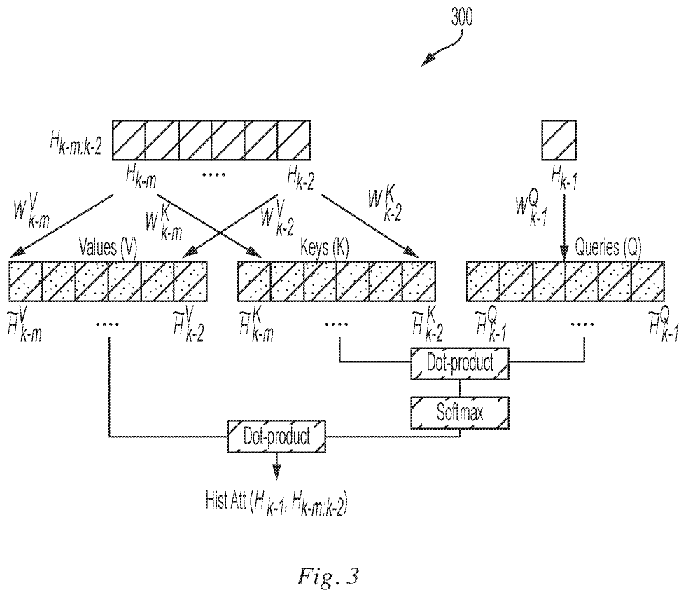

Using this mechanism, HistAtt computes the relationship between the last hidden state Hₖ₋₁ and the earlier hidden states H_{k-m:k-2} at time step k (See FIG. 3). H_{k-m:k-2} is the set of previous hidden states, (H_{k-m; Hk-m-1}; . . . H_{k-3;Hk-2}). The history attention mechanism can be formulated as follows shown in Equation 3:

$$HistAtt ( {H}_{k - 1} , {H}_{k - m : k - 2} ) = {\sum }_{i = 2}^{n} softmax ( {\tilde{H}}_{k - 1}^{Q} \cdot {\tilde{H}}_{k - i}^{K} ) \cdot {\tilde{H}}_{k - i}^{V} , \\ {\tilde{H}}_{i}^{j} = {W}_{i}^{j} {H}_{i} + {b}_{i}^{j} , {}^{1} j ∈ \{ Q , K , V \} . \qquad Equation 3$$

In another embodiment (not shown), the HistAtt may be employed in the traditional ConvLSTM (Equation 1) by adding HistAtt(Hₖ₋₁, H_{k-m:k-2}) in addition to the input and the previous states (Xₖ, Hₖ₋₁, Cₖ₋₁) in Equation 1. This direct extension may be referred to as Single LH-STM: Hₖ=SingleConvLSTM(Xₖ, Hₖ₋₁, Cₖ₋₁, HistAtt(Hₖ₋₁, H_{k-m:k-2})) and may be represented by Equation 4.

iₖ=σ(Wᵢ*Xₖ+Mᵢ*Hₖ₋₁+HistAtt(Hₖ₋₁,H_{k-m:k-2})+bᵢ),

fₖ=σ(W_{f}*Xₖ+M_{f}*Hₖ₋₁+HistAtt(Hₖ₋₁,H_{k-m:k-2})+b_{f}),

oₖ=σ(Wₒ*Xₖ+Mₒ*Hₖ₋₁+HistAtt(Hₖ₋₁,H_{k-m:k-2})+bₒ),

Ĉₖ=tan h(W_{ĉ}*Xₖ+M_{ĉ}*Hₖ₋₁+HistAtt(Hₖ₋₁,H_{k-m:k-2})+b_{ĉ}),

Cₖ=iₖ⊙Ĉₖ+fₖ⊙Ĉₖ₋₁,

Hₖ=oₖ⊙ tan h(Cₖ), Equation 4

Going back to the dual recurrent neural network architecture system 200, U-LSTM updates the states Hₖ and Cₖ for the time step k, given the input Xₖ, previous cell state Cₖ₋₁, and the output of the H-LSTM Hₖ₋₁′, by replacing Hₖ₋₁ with Hₖ₋₁′ in Equation 1. Equation 5 represents the U-LSTM, as modified from Equation 1.

C′ₖ,H′ₖ=ConvLSTM(Xₖ,H′ₖ₋₁,Cₖ₋₁), where:

iₖ=σ(Wᵢ*Xₖ+Mᵢ*Hₖ₋₁′+bᵢ),

fₖ=σ(W_{f}*Xₖ+M_{f}*Hₖ₋₁′+b_{f}),

oₖ=σ(Wₒ*Xₖ+Mₒ*Hₖ₋₁′+bₒ),

Ĉₖ=tan h(W_{ĉ}*Xₖ+M_{ĉ}*Hₖ₋₁′+b_{ĉ}),

Cₖ=fₖ⊙Cₖ₋₁+iₖ⊙Ĉₖ,

Hₖ=oₖ⊙ tan h(Cₖ), Equation 5

Optional Implementation Details

ConvLSTM is a popular building block for spatio-temporal sequence forecasting problems. Two recent state-of-the-art ConvLSTM-based architectures include the deep ConvLSTM model (ConvLSTM-12) and the context-aware video prediction model (ContextVP-4). Both models can capture sufficient spatio-temporal context, such as for video prediction. As described above, the ConvLSTM block is replaced with LH-STM.

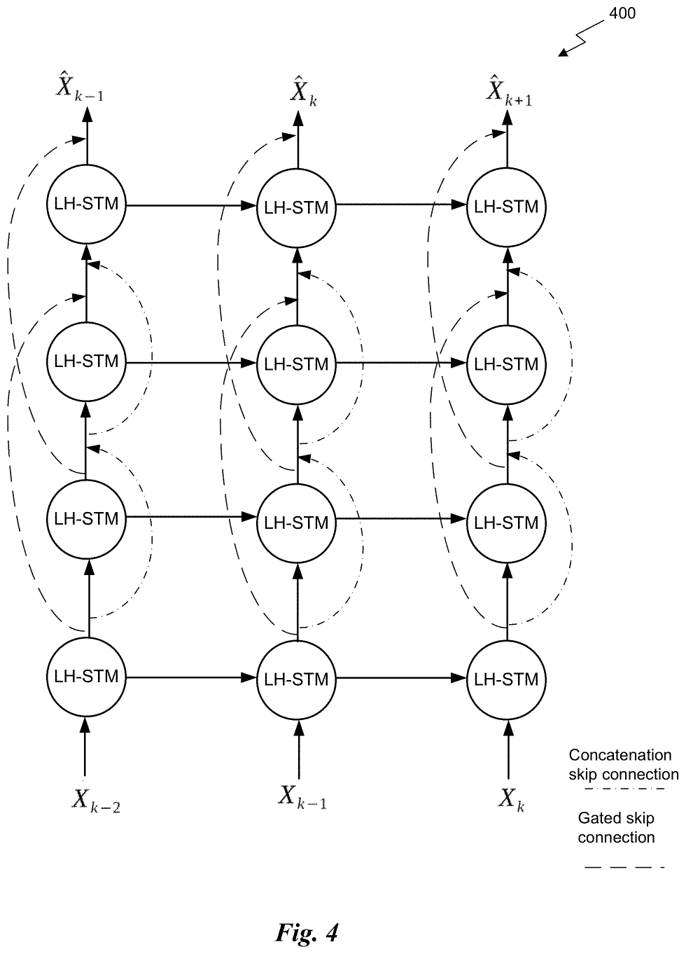

Additionally, two types of skip connections may be utilized to avoid the problem of vanishing gradients and allow long-term prediction, as shown in FIG. 4. These skip connections include those: (a) between previous and the current recurrent layers, and (b) across layers.

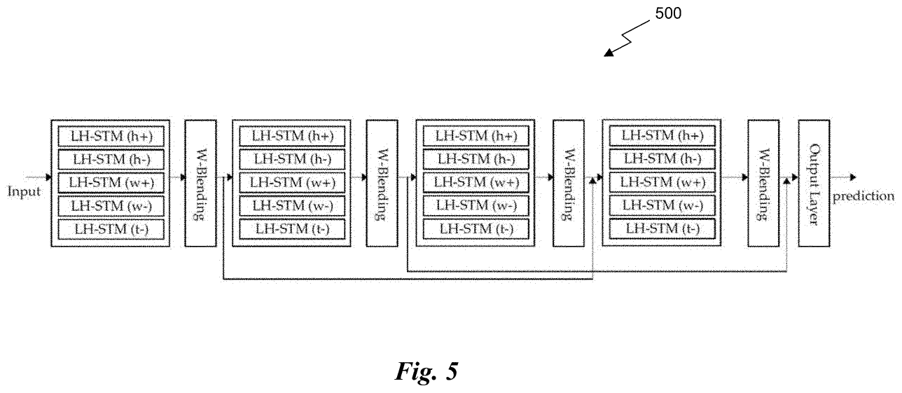

ConvLSTM-12, as represented in Equation 1, is a stack of 12 ConvLSTM layers with six skip connections between the first and last six layers, i.e., (1-7), (2-8), . . . (6-12). ContextVP-4 consists of 4 layers of five directional Parallel Multi-Dimensional LSTM (PMD) units along the h+, h−, w+, w−, and t− recurrence directions, as shown in FIG. 5. A PMD unit along the time direction (t−) is mathematically equivalent to a standard ConvLSTM (Equation 1). By using LSTM connectivities across the temporal and spatial dimensions, each processing layer covers the entire context in a video or other input sequence. Weighted blending, directional weight sharing (DWS), and two skip connections between the layers 1-3 and 2-4 may also be included.

The weighted blending layer learns the relative importance of each direction during training according to Equation 6.

Sₖ=[Hₖ^{h+},Hₖ^{h-},Hₖ^{w+},Hₖ^{w-}Hₖ^{t-}].

Mₖ=f(Wₖ·Sₖ+bₖ), Equation 6

where H is the output of the PMD units from h+, h−, w+, w−, and t− directions, and W is the weight matrix.

The DWS provides weights and biases of the PMD units in opposite directions. This means that the 11 h+ and h− directions and the w+ and w− directions are shared.

As mentioned above, of skip connections may be utilized for the dual recurrent neural network architecture system 200, to improve performance. In one embodiment, a concatenation-based skip connection may be used for long-term gradient propagation. The concatenation-based skip connection will concatenate outputs of the previous and current LSTM layers. In another embodiment, gated skip connection ma be added across layers. The gated skip connection is a multiplicative gate added to control the flow of information across layers. It stabilizes learning as depth increases.

A layer is formulated as shown in Equation 7.

Y=Hₗ·Tₗ+Xₗ₋ᵢ·(1−Tₗ), i<l, Equation 7

where Hₗ=Xₗ·Wₗ^{H}+b^{H} and Tₗ=σ(Xₗ·Wₗ^{T}+b^{T}). Xₗ is the input at the l^{th} layer. T is a gate, and Hₗ is the transformation of the input at the layer l.

As also mentioned above, a loss function may be utilized to train the history recurrent neural network and/or the update recurrent neural network. In one embodiment, the loss function) to train the networks is [symbol] ₚ(Y,\hat{X})=∥Y−\hat{X}∥ₚ, where Y and \hat{X} are the target and the predicted frames, respectively. In one embodiment, p=1. A perceptual loss [symbol] ₚₜ may also be used to improve visual quality, which computes the cosine distance between the feature maps extracted from a VGG-16 network pre-trained on the ImageNet dataset as

$${ℒ}_{pl} ( y , \hat{x} ) = 1 \hat{-} \frac{1}{l} {\sum }_{l} \frac{1}{{h}^{l} \times {w}^{l}} {\sum }_{{h}^{l} , {w}^{l}} ( {φ ( y )}_{l} \cdot {φ ( \hat{x} )}_{l} ) ,$$

where ϕ(y)t and ϕ(\hat{x})t are the feature maps of the target and the predicted frames Y and \hat{X} respectively at the layer l. The size of the feature map at layer l is h^{l}×ŵ^{l}.

### Machine Learning

Deep neural networks (DNNs), including deep learning models, developed on processors have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions. Inferencing is less compute-intensive than training, being a latency-sensitive process where a trained neural network is applied to new inputs it has not seen before to classify images, translate speech, and generally infer new information.

### Inference and Training Logic

As noted above, a deep learning or neural learning system needs to be trained to generate inferences from input data. Details regarding inference and/or training logic 615 for a deep learning or neural learning system are provided below in conjunction with FIGS. 6A and/or 6B.

In at least one embodiment, inference and/or training logic 615 may include, without limitation, a data storage 601 to store forward and/or output weight and/or input/output data corresponding to neurons or layers of a neural network trained and/or used for inferencing in aspects of one or more embodiments. In at least one embodiment data storage 601 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of data storage 601 may be included with other on-chip or off-chip data storage, including a processor's L1, L2, or L3 cache or system memory.

In at least one embodiment, any portion of data storage 601 may be internal or external to one or more processors or other hardware logic devices or circuits. In at least one embodiment, data storage 601 may be cache memory, dynamic randomly addressable memory (“DRAM”), static randomly addressable memory (“SRAM”), non-volatile memory (e.g., Flash memory), or other storage. In at least one embodiment, choice of whether data storage 601 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 615 may include, without limitation, a data storage 605 to store backward and/or output weight and/or input/output data corresponding to neurons or layers of a neural network trained and/or used for inferencing in aspects of one or more embodiments. In at least one embodiment, data storage 605 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, any portion of data storage 605 may be included with other on-chip or off-chip data storage, including a processor's L1, L2, or L3 cache or system memory. In at least one embodiment, any portion of data storage 605 may be internal or external to on one or more processors or other hardware logic devices or circuits. In at least one embodiment, data storage 605 may be cache memory, DRAM, SRAM, non-volatile memory (e.g., Flash memory), or other storage. In at least one embodiment, choice of whether data storage 605 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, data storage 601 and data storage 605 may be separate storage structures. In at least one embodiment, data storage 601 and data storage 605 may be same storage structure. In at least one embodiment, data storage 601 and data storage 605 may be partially same storage structure and partially separate storage structures. In at least one embodiment, any portion of data storage 601 and data storage 605 may be included with other on-chip or off-chip data storage, including a processor's L1, L2, or L3 cache or system memory.

In at least one embodiment, inference and/or training logic 615 may include, without limitation, one or more arithmetic logic unit(s) (“ALU(s)”) 610 to perform logical and/or mathematical operations based, at least in part on, or indicated by, training and/or inference code, result of which may result in activations (e.g., output values from layers or neurons within a neural network) stored in an activation storage 620 that are functions of input/output and/or weight parameter data stored in data storage 601 and/or data storage 605. In at least one embodiment, activations stored in activation storage 620 are generated according to linear algebraic and or matrix-based mathematics performed by ALU(s) 610 in response to performing instructions or other code, wherein weight values stored in data storage 605 and/or data 601 are used as operands along with other values, such as bias values, gradient information, momentum values, or other parameters or hyperparameters, any or all of which may be stored in data storage 605 or data storage 601 or another storage on or off-chip. In at least one embodiment, ALU(s) 610 are included within one or more processors or other hardware logic devices or circuits, whereas in another embodiment, ALU(s) 610 may be external to a processor or other hardware logic device or circuit that uses them (e.g., a co-processor). In at least one embodiment, ALUs 610 may be included within a processor's execution units or otherwise within a bank of ALUs accessible by a processor's execution units either within same processor or distributed between different processors of different types (e.g., central processing units, graphics processing units, fixed function units, etc.). In at least one embodiment, data storage 601, data storage 605, and activation storage 620 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 620 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 620 may be cache memory, DRAM, SRAM, non-volatile memory (e.g., Flash memory), or other storage. In at least one embodiment, activation storage 620 may be completely or partially within or external to one or more processors or other logical circuits. In at least one embodiment, choice of whether activation storage 620 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 615 illustrated in FIG. 6A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 615 illustrated in FIG. 6A may be used in conjunction with central processing unit (“CPU”) hardware, graphics processing unit (“GPU”) hardware or other hardware, such as field programmable gate arrays (“FPGAs”).

FIG. 6B illustrates inference and/or training logic 615, according to at least one embodiment. In at least one embodiment, inference and/or training logic 615 may include, without limitation, hardware logic in which computational resources are dedicated or otherwise exclusively used in conjunction with weight values or other information corresponding to one or more layers of neurons within a neural network. In at least one embodiment, inference and/or training logic 615 illustrated in FIG. 6B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 615 illustrated in FIG. 6B may be used in conjunction with central processing unit (CPU) hardware, graphics processing unit (GPU) hardware or other hardware, such as field programmable gate arrays (FPGAs). In at least one embodiment, inference and/or training logic 615 includes, without limitation, data storage 601 and data storage 605, which may be used to store weight values and/or other information, including bias values, gradient information, momentum values, and/or other parameter or hyperparameter information. In at least one embodiment illustrated in FIG. 6B, each of data storage 601 and data storage 605 is associated with a dedicated computational resource, such as computational hardware 602 and computational hardware 606, respectively. In at least one embodiment, each of computational hardware 606 comprises one or more ALUs that perform mathematical functions, such as linear algebraic functions, only on information stored in data storage 601 and data storage 605, respectively, result of which is stored in activation storage 620.

In at least one embodiment, each of data storage 601 and 605 and corresponding computational hardware 602 and 606, respectively, correspond to different layers of a neural network, such that resulting activation from one “storage/computational pair 601/602” of data storage 601 and computational hardware 602 is provided as an input to next “storage/computational pair 605/606” of data storage 605 and computational hardware 606, in order to mirror conceptual organization of a neural network. In at least one embodiment, each of storage/computational pairs 601/602 and 605/606 may correspond to more than one neural network layer. In at least one embodiment, additional storage/computation pairs (not shown) subsequent to or in parallel with storage computation pairs 601/602 and 605/606 may be included in inference and/or training logic 615.

### Neural Network Training and Deployment

FIG. 7 illustrates another embodiment for training and deployment of a deep neural network. In at least one embodiment, untrained neural network 706 is trained using a training dataset 702. In at least one embodiment, training framework 704 is a PyTorch framework, whereas in other embodiments, training framework 704 is a Tensorflow, Boost, Caffe, Microsoft Cognitive Toolkit/CNTK, MXNet, Chainer, Keras, Deeplearning4j, or other training framework. In at least one embodiment training framework 704 trains an untrained neural network 706 and enables it to be trained using processing resources described herein to generate a trained neural network 708. In at least one embodiment, weights may be chosen randomly or by pre-training using a deep belief network. In at least one embodiment, training may be performed in either a supervised, partially supervised, or unsupervised manner.

In at least one embodiment, untrained neural network 706 is trained using supervised learning, wherein training dataset 702 includes an input paired with a desired output for an input, or where training dataset 702 includes input having known output and the output of the neural network is manually graded. In at least one embodiment, untrained neural network 706 is trained in a supervised manner processes inputs from training dataset 702 and compares resulting outputs against a set of expected or desired outputs. In at least one embodiment, errors are then propagated back through untrained neural network 706. In at least one embodiment, training framework 704 adjusts weights that control untrained neural network 706. In at least one embodiment, training framework 704 includes tools to monitor how well untrained neural network 706 is converging towards a model, such as trained neural network 708, suitable to generating correct answers, such as in result 714, based on known input data, such as new data 712. In at least one embodiment, training framework 704 trains untrained neural network 706 repeatedly while adjust weights to refine an output of untrained neural network 706 using a loss function and adjustment algorithm, such as stochastic gradient descent. In at least one embodiment, training framework 704 trains untrained neural network 706 until untrained neural network 706 achieves a desired accuracy. In at least one embodiment, trained neural network 708 can then be deployed to implement any number of machine learning operations.

In at least one embodiment, untrained neural network 706 is trained using unsupervised learning, wherein untrained neural network 706 attempts to train itself using unlabeled data. In at least one embodiment, unsupervised learning training dataset 702 will include input data without any associated output data or “ground truth” data. In at least one embodiment, untrained neural network 706 can learn groupings within training dataset 702 and can determine how individual inputs are related to untrained dataset 702. In at least one embodiment, unsupervised training can be used to generate a self-organizing map, which is a type of trained neural network 708 capable of performing operations useful in reducing dimensionality of new data 712. In at least one embodiment, unsupervised training can also be used to perform anomaly detection, which allows identification of data points in a new dataset 712 that deviate from normal patterns of new dataset 712.

In at least one embodiment, semi-supervised learning may be used, which is a technique in which in training dataset 702 includes a mix of labeled and unlabeled data. In at least one embodiment, training framework 704 may be used to perform incremental learning, such as through transferred learning techniques. In at least one embodiment, incremental learning enables trained neural network 708 to adapt to new data 712 without forgetting knowledge instilled within network during initial training.

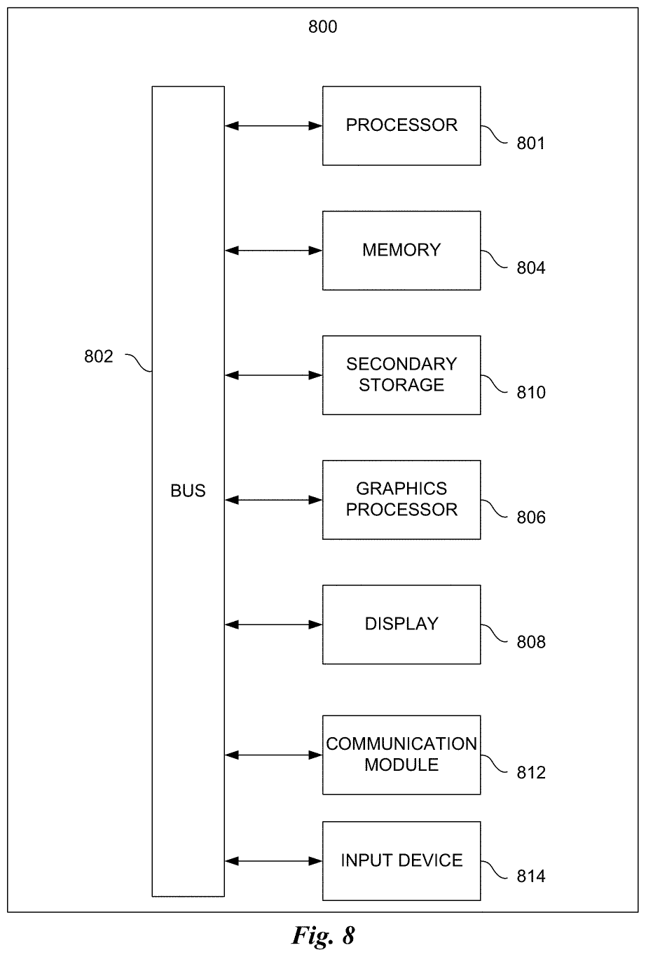

FIG. 8 illustrates an exemplary system 800, in accordance with one embodiment. The system 800 may be used to carry out and/or implement the functionality of any of the embodiments described above with reference to FIGS. 1-7.

As shown, a system 800 is provided including at least one central processor 801 which is connected to a communication bus 802. The system 800 also includes main memory 804 [e.g. random access memory (RAM), etc.]. The system 800 also includes a graphics processor 806 and a display 808.

The system 800 may also include a secondary storage 810. The secondary storage 810 includes, for example, a hard disk drive and/or a removable storage drive, representing a floppy disk drive, a magnetic tape drive, a compact disk drive, etc. The removable storage drive reads from and/or writes to a removable storage unit in a well-known manner.

Computer programs, or computer control logic algorithms, may be stored in the main memory 804, the secondary storage 810, and/or any other memory, for that matter. Such computer programs, when executed, enable the system 800 to perform various functions (as set forth above, for example). Memory 804, storage 810 and/or any other storage are possible examples of non-transitory computer-readable media.

The system 800 may also include one or more communication modules 812. The communication module 812 may be operable to facilitate communication between the system 800 and one or more networks, and/or with one or more devices through a variety of possible standard or proprietary communication protocols (e.g. via Bluetooth, Near Field Communication (NFC), Cellular communication, etc.).

As also shown, the system 800 may include one or more input devices 814. The input devices 814 may be wired or wireless input device. In various embodiments, each input device 814 may include a keyboard, touch pad, touch screen, game controller (e.g. to a game console), remote controller (e.g. to a set-top box or television), or any other device capable of being used by a user to provide input to the system 800.

As described herein, a method, computer readable medium, and system are disclosed to provide a dual recurrent neural network architecture for modeling long-term dependencies in sequential data. In accordance with FIGS. 1-5, the dual recurrent neural network architecture may include multiple recurrent neural networks. In one embodiment, the recurrent neural networks may be stored (partially or wholly) in one or both of data storage 601 and 605 in inference and/or training logic 615 as depicted in FIGS. 6A and 6B. Training and deployment of the recurrent neural networks may be performed as depicted in FIG. 7 and described herein. Use of the recurrent neural networks to make predictions may be performed using one or more systems 800 as depicted in FIG. 8 and described herein.

What is claimed is:

1. A method, comprising:
identifying a set of hidden states associated with an input sequence;
processing, by a history recurrent neural network, the set of hidden states to learn a cell state transition function associated with the input sequence;
updating, by an update recurrent neural network, a current cell state and corresponding hidden states for each input of the input sequence, based on the cell state transition function.

2. The method of claim 1, wherein the input sequence is a sequence of frames of video.

3. The method of claim 1, wherein the input sequence is a sequence of speech.

4. The method of claim 1, wherein the history recurrent neural network and the update recurrent neural network are long short-term memory (LSTM) networks.

5. The method of claim 1, wherein the history recurrent neural network and the update recurrent neural network are convolutional long short-term memory (ConvLSTM) networks.

6. The method of claim 1, wherein the history recurrent neural network and the update recurrent neural network are gated recurrent unit (GRU) networks.

7. The method of claim 1, wherein the set of hidden states associated with the input sequence includes all hidden states associated with the input sequence.

8. The method of claim 1, wherein the history recurrent neural network includes an attention mechanism.

9. The method of claim 8, wherein the history recurrent neural network applies the attention mechanism to the set of hidden states associated with the input sequence.

10. The method of claim 9, wherein the attention mechanism computes, for a time step k, a relationship between a last hidden state and each earlier hidden state to indicate a weight for each earlier hidden state.

11. The method of claim 1, wherein a loss function is utilized to train the history recurrent neural network and the update recurrent neural network.

12. The method of claim 11, wherein a perceptual loss is further utilized to train the history recurrent neural network and the update recurrent neural network.

13. The method of claim 1, wherein a skip connection is utilized between previous and current recurrent layers.

14. The method of claim 13, wherein the skip connection concatenates output of the previous and current recurrent layers.

15. The method of claim 1, wherein a gated skip connection is utilized across layers.

16. The method of claim 15, wherein the gated skip connection is a multiplicative gate added to control a flow of information across layers.

17. The method of claim 1, wherein the history recurrent neural network and the update recurrent neural network form a dual recurrent neural network architecture modeling long-term dependencies in sequential data represented by the input sequence.

18. The method of claim 17, further comprising using the dual recurrent neural network architecture to predict long-term future data from the input sequence.

19. A system, comprising:
a history recurrent neural network configured to process a set of hidden states associated with an input sequence to learn a cell state transition function associated with the input sequence; and
an update recurrent neural network configured to update a current cell state and corresponding hidden states for each input of the input sequence, based on the cell state transition function.

20. The system of claim 19, wherein the input sequence is a sequence of frames of video or a sequence of speech.

21. The system of claim 19, wherein the history recurrent neural network and the update recurrent neural network are:
long short-term memory (LSTM) networks,
convolutional long short-term memory (ConvLSTM) networks, or
gated recurrent unit (GRU) networks.

22. The system of claim 19, wherein the set of hidden states associated with the input sequence includes all hidden states associated with the input sequence.

23. The system of claim 19, wherein the history recurrent neural network includes an attention mechanism.

24. The system of claim 23, wherein the history recurrent neural network applies the attention mechanism to the set of hidden states associated with the input sequence.

25. The system of claim 24, wherein the attention mechanism computes, for a time step k, a relationship between a last hidden state and each earlier hidden state to indicate a weight for each earlier hidden state.

26. The system of claim 19, wherein a loss function is utilized to train the history recurrent neural network and the update recurrent neural network.

27. The system of claim 26, wherein a perceptual loss is further utilized to train the history recurrent neural network and the update recurrent neural network.

28. The system of claim 19, wherein a skip connection is utilized between previous and current recurrent layers.

29. The system of claim 28, wherein the skip connection concatenates output of the previous and current recurrent layers.

30. The system of claim 19, wherein a gated skip connection is utilized across layers.

31. The system of claim 30, wherein the gated skip connection is a multiplicative gate added to control a flow of information across layers.

32. The system of claim 19, wherein the history recurrent neural network and the update recurrent neural network form a dual recurrent neural network architecture modeling long-term dependencies in sequential data represented by the input sequence.

33. The system of claim 32, further comprising using the dual recurrent neural network architecture to predict long-term future data from the input sequence.

34. A non-transitory computer-readable media storing computer instructions that, when executed by one or more processors, cause the one or more processors to perform a method comprising:
identifying a set of hidden states associated with an input sequence;
processing, by a history recurrent neural network, the set of hidden states to learn a cell state transition function associated with the input sequence;
updating, by an update recurrent neural network, a current cell state and corresponding hidden states for each input of the input sequence, based on the cell state transition function.
